(19) United States
(12) Patent Application Publication
(10) Pub. No.: US 2005/0002641 A1
(43) Pub. Date: Jan. 6, 2005

(54) Serial bus-connectable video recording device

(76) Inventor: Atsushi Takagi, Osaka (JP)

Correspondence Address: CROWELL & MORING LLP;INTELLECTUAL PROPERTY GROUP, P.O. BOX 14300, WASHINGTON, DC, 20044-4300, US

(21) Appl. No.: 10/880,453

(22) Filed: Jul. 1, 2004

(30) Foreign Application Priority Data
Jul. 1, 2003 (JP) 2003-189740

(51) Int. Cl. H04N 5/76

(52) U.S. Cl. 386/46; 386/125

(57) ABSTRACT

When a user selects a channel in a frequency band where a built-in tuner of a video recording device cannnot be tuned, but where a built-in tuner of an external device can be tuned, then the video recording device sends a control command for channel change to the external device. An input line of broadcast signals to a video recording and reproducing unit of the video recording device is switched from an input line, which is from the built-in tuner of the video recording device to the recording and reproducing unit of the video recording device, to a further input line, which is from the external device to the recording and reproducing unit of the video recording device. Thereby, broadcast signals input from the external device via an IEEE 1394 serial bus are recorded by the video recording and reproducing unit of the video recording device. Thus, even in the case where a built-in tuner of the video recording device is incapable of extracting broadcast signals of a channel of a broadcast program to be recorded, the broadcast program can be recorded by the video recording device.

### BACKGROUND OF THE INVENTION

1. Field of the Invention

The present invention relates to a serial bus-connectable video recording device, such as digital VTR (Video Tape Recorder), DVD (Digital Versatile Disc) recorder or the like, that can be connected to a serial bus such as IEEE 1394 serial bus.

2. Description of the Related Art

Japanese Laid-open Patent Publication 2001-285729 discloses a bus-connected video recording device which can display, on a monitor, video images of a broadcast channel selected by a built-in tuner thereof, while recording video signals of a further broadcast channel selected by a tuner of a further device connected to the video recording device via the bus.

However, the video recording device of the Japanese Laid-open Patent Publication 2001-285729 has a problem that it cannot record video signals of a broadcast channel which cannot be selected by the built-in tuner thereof.

### SUMMARY OF THE INVENTION

An object of the present invention is to provide a serial bus-connectable video recording device which can record a broadcast program even in the case where a built-in tuner of the video recording device is incapable of extracting broadcast signals of the broadcast program to be recorded.

According to the present invention, this object is achieved by a serial bus-connectable video recording device comprising: an operating unit to perform operations including channel selection of a channel of a broadcast program to be recorded; a built-in tuner to extract, from broadcast signals received by an antenna, broadcast signals of a channel selected by a user using the operating unit; a decoder to separate and decode the broadcast signals, extracted by the built-in tuner, into video signals and audio signals; a video recording unit to record the video signals and the audio signals decoded by the decoder; an interface unit to send and receive data via a serial bus to and from a further device on the serial bus, the further device having a further built-in tuner; an input changeover switch to switch between an input line (hereafter referred to as first input line) of broadcast signals from the built-in tuner of the video recording device via the decoder to the video recording unit and a further input line (hereafter referred to as second input line) of broadcast signals from the further device to the video recording unit; and a microprocessor to control operations of the operating unit, the built-in tuner, the decoder, the video recording unit, the interface unit and the input changeover switch of the video recording device.

Therein, when a channel of a broadcast program to be recorded is selected by a user using the operating unit while the video recording device is connected to the further device via the serial bus, the microprocessor controls the built-in tuner of the video recording device to extract broadcast signals of the channel selected by the operating unit, while maintaining the first input line as the input line of broadcast signals to the video recording unit, in the case where the broadcast signals of the channel selected by the operating unit are broadcast signals in a given frequency band which the built-in tuner of the video recording device is capable of extracting. On the other hand, in the case where the broadcast signals of the channel selected by the operating unit are broadcast signals in a further given frequency band which the built-in tuner of the video recording device is incapable of extracting, and which the further built-in tuner of the further device is capable of extracting, then the microprocessor sends a control command for channel change to the further device, and controls the input changeover switch to switch the input line of broadcast signals to the video recording unit from the first input line to the second input line in order for the further built-in tuner of the further device to extract the broadcast signals of the channel selected by the operating unit.

Thus, even in the case where the built-in tuner of the video recording device is incapable of extracting broadcast signals of the broadcast program to be recorded, the video recording unit of the video recording device can record the broadcast program if the built-in tuner of the further device is capable of extracting the broadcast signals of the broadcast program.

Preferably, the serial bus-connectable video recording device further comprises channel storage means to store channel information corresponding to broadcast signals which the built-in tuner of the video recording device is capable of extracting as well as channel information corresponding to broadcast signals which the further built-in tuner of the further device is capable of extracting, wherein on the basis of the channel information stored in the channel storage means, the microprocessor determines whether the broadcast signals of the channel selected by the operating unit are broadcast signals which the built-in tuner of the video recording device is capable of extracting or are broadcast signals which the further built-in tuner of the further device is capable of extracting.

Further preferably, the serial bus is an IEEE 1394 serial bus, and the interface unit is an interface circuit to send and receive data to and from the further device on the IEEE 1394 bus.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a schematic electrical block diagram showing a VTR, which is a video recording device according to an embodiment of the present invention, and a further VTR connected to the VTR;

FIG. 2 is a schematic chart showing data stored in a memory of the VTR;

FIG. 3 is a schematic channel information table, in the memory, showing an example of channel information stored therein; and

FIG. 4 is a schematic flow chart showing a channel selection process at the time of video recording by the VTR.

### DESCRIPTION OF THE PREFERRED EMBODIMENTS

An embodiment of the present invention will be described hereinafter with reference to the drawings.

A video recording device according to the present invention is a VTR (Video Tape Recorder) which is to be connected to an IEEE 1394 bus (hereafter referred to as simply bus) and has a built-in tuner capable of extracting BS (Broadcasting Satellite) broadcast signals. The VTR is network-connected via the bus to a further VTR having a built-in tuner capable of extracting CS (Communications Satellite) broadcast signals.

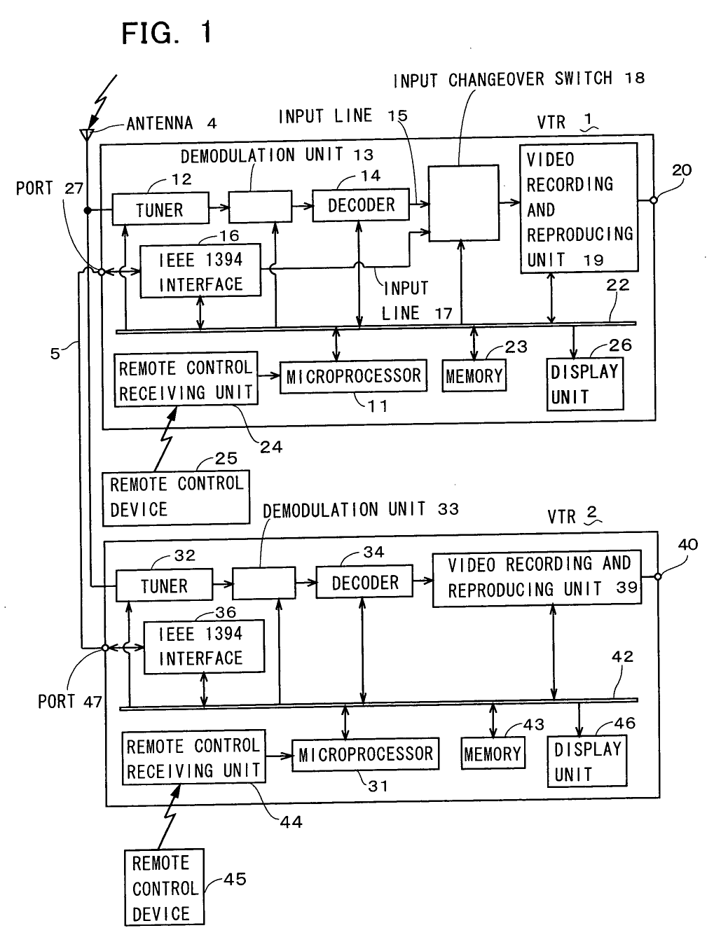

FIG. 1 shows an electrical block diagram of a VTR 1, which is a video recording device according to an embodiment of the present invention, and of a further VTR 2 connected to the VTR 1 via a bus. The VTR 1 comprises a microprocessor 11 to control the whole device. The microprocessor 11 is connected via an internal bus 22 to and controls other elements in the VTR 1 that are a tuner 12, a demodulation unit 13, a decoder 14, an IEEE 1394 interface 16 (claimed interface unit) (hereafter referred to as simply interface), an input changeover switch 18, a video recording and reproducing unit 19 (claimed video recording unit), a memory 23 and a display unit 26.

The above-described tuner 12 is capable of extracting broadcast signals of UHF (Ultra High Frequency) broadcasts, VHF (Very High Frequency) broadcasts and BS broadcasts. From broadcast signals received by an antenna 4, the tuner 12 extracts broadcast signals of a channel selected by a user. In accordance with the broadcasting system of the broadcast signals, the demodulation unit 13 demodulates the broadcast signals extracted by the tuner 12. The decoder 14 separates and decodes the broadcast signals, having been demodulated by the demodulation unit 13, into video signals, audio signals and the like. The interface 16 is an interface circuit to send and receive data to and from other devices on the bus, and sends and receives data to and from the VTR 2 via an IEEE 1394 serial bus cable 5 (hereafter referred to as simply bus cable). The input changeover switch 18 switches between: an input line 15 (claimed first input line) of broadcast signals from the built-in tuner 12 via the decoder 14 to the video recording and reproducing unit 19; and an input line 17 (claimed second input line) of broadcast signals from the further VTR 2 to the video recording and reproducing unit 19 of the VTR 1.

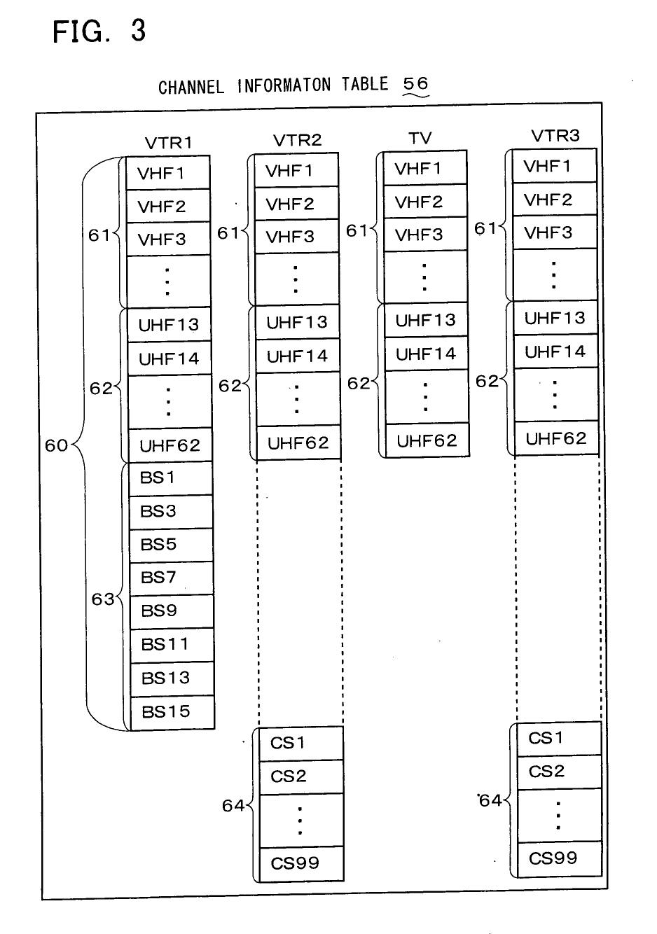

The video recording and reproducing unit 19 records, on a video tape, the video signals, the audio signals and the like having been decoded by the decoder 14, and reproduces such video signals, audio signals and the like recorded on the video tape. The memory 23 stores various data including a channel information table (refer to FIG. 3) storing channels in frequency bands where the above-described built-in tuner 12 can be tuned (channels corresponding to broadcast signals which the tuner 12 is capable of extracting), and also storing channels in frequency bands where a built-in tuner (32) of the further VTR 2 can be tuned (channels corresponding to broadcast signals which the built-in tuner (32) of the VTR 2 is capable of extracting).

The display unit 26 displays various information such as channels stored in the channel information table. The microprocessor 11 is connected to a remote control receiving unit 24 to receive operating signals from a remote control device 25 (claimed operating unit). The remote control device 25 is used to perform operations including channel selection and start and stop commands of video recording. The VTR 1 is further provided with a video and audio output terminal 20 to output, to external devices, video signals and audio signals having been decoded by the decoder 14, and also with a port 27 to connect the bus cable 5 thereto.

Similarly as for the VTR 1, the above-described VTR 2 comprises a microprocessor 31, a tuner 32, a demodulation unit 33, a decoder 34, an IEEE 1394 interface 36 (hereafter referred to as simply interface), a recording and reproducing unit 39, a memory 43, a display unit 46, and a remote control receiving unit 44 to receive operating signals from a remote control device 45. The VTR 2 also comprises an internal bus 42 via which the microprocessor 31 is connected to the tuner 32, the demodulation unit 33, the decoder 34, the interface 36, the video recording and reproducing unit 39, the memory 43 and the display unit 46. In contrast to the VTR 1, the VTR 2 does not have an input changeover switch to switch between input lines of broadcast signals to the recording and reproducing unit 39. Thus, the VTR 2 cannot record, by the recording and reproducing unit 39, video signals and audio signals input from other devices connected via the bus cable 5. Besides, the memory 43 does not store such channel information table (refer to FIG. 3) as stored in the memory 23 of the VTR 1.

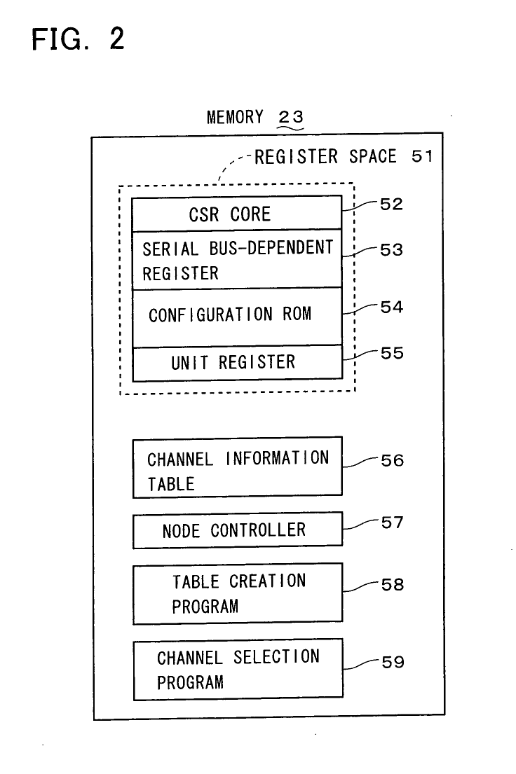

FIG. 2 shows various data stored in the memory 23 of the above-described VTR 1. The memory 23 has a register space 51 to be used for information exchange among respective network-connected devices on the bus. This register space 51 comprises: a CSR (Control and Status Registers) core 52 to be used for node control; a serial bus-dependent register 53 which is a register for bus management; a configuration ROM (read-only memory) 54 storing e.g. information about performances of the VTR 1; and a unit register 55 which is a register specific to each device. The memory 23 further stores a channel information table 56 to store channels in frequency bands where the built-in tuner 12 of the VTR 1 can be tuned as well as channels in frequency bands where the built-in tuner 32 of the VTR 2 can be tuned. This channel information table 56 corresponds to the claimed channel storage means. The memory 23 furthermore stores a node controller 57 to control nodes, a table creation program 58 to create the above-described channel information table 56, and a channel selection program 59 to select channels of broadcast programs to be recorded.

FIG. 3 shows an example of channel information stored in the above-described channel information table 56. It shows an example of channel information 60 of each device in the case where a TV and a VTR 3, each as a network-connected device having a tuner, are connected to the bus in addition to the above-described VTR 1 and VTR 2. The channel information 60 of each network-connected device comprises at least one of VHF channel information 61, UHF channel information 62, BS channel information 63 and CS channel information 64. In the present example, the channels in frequency bands where the tuner 12 of the VTR 1 can be tuned are VHF 1 to 12, UHF 13 to 62, and BS 1, 3, 5, 7, 9, 11, 13 and 15, while the channels in frequency bands where the tuner 32 of the VTR 2 can be tuned are VHF 1 to 12, UHF 13 to 62, and CS 1 to 99. On the other hand, the channels in frequency bands where the tuner of the TV can be tuned are VHF 1 to 12 and UHF 13 to 62, while the channels in frequency bands where the tuner of the VTR 3 can be tuned are the same as those in the frequency bands where the tuner 32 of the VTR 2 can be tuned.

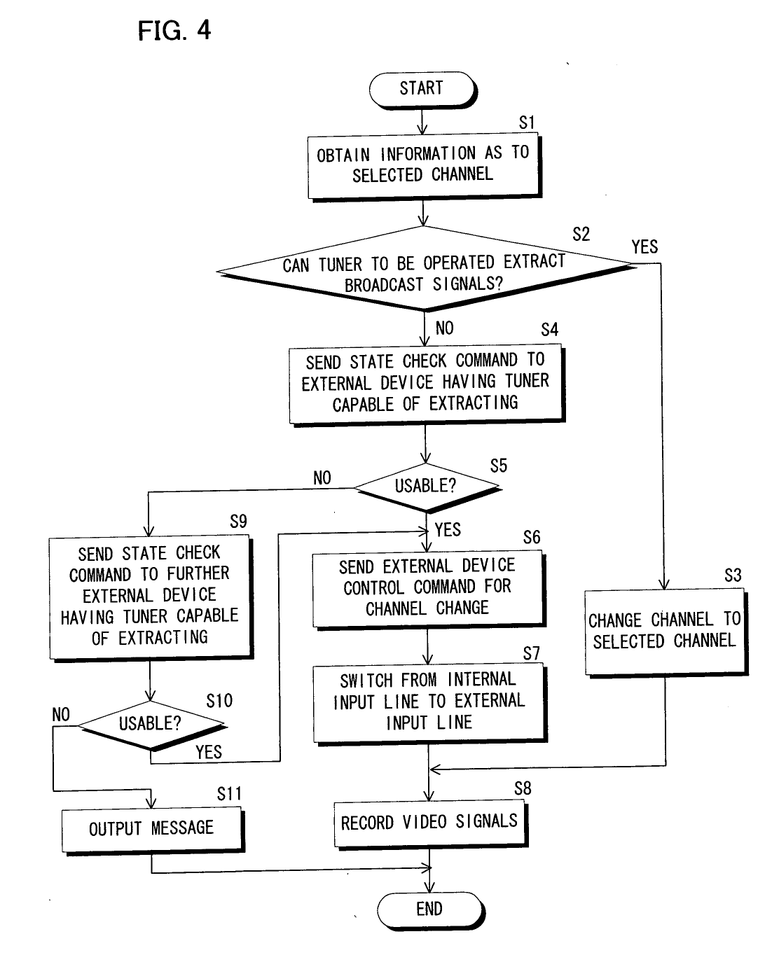

Hereinafter, referring to a flow chart of FIG. 4, a channel selection process at the time of video recording by the VTR 1 will be described. This channel selection process corresponds to the contents of the channel selection program 59 in the above-illustrated FIG. 2, and is performed by the microprocessor 11 in accordance with the instructions of the channel selection program 59 at the time of video recording. When a user, using the remote control device 25, requires a selection menu display of channels of broadcast programs to be recorded, then the microprocessor 11 reads the channel information table 56 in the memory 23, and displays, on the display unit 26, a list of the channels in the frequency bands where the tuner 12 of the VTR 1 can be tuned as well as the channels in the frequency bands where the tuners of the other network-connected devices can be tuned.

When the user, using the remote control device 25, thereafter selects a channel of a broadcast program, to be recorded, from the channels displayed on the display unit 26, then the microprocessor 11 obtains information as to which one of the channels has been selected (S1). On the basis of the thus obtained information and the channel information 60 (refer to FIG. 3) of each network-connected device stored in the channel information table 56, the microprocessor 11 determines whether or not the tuner 12 in the VTR 1, which is to be operated, is capable of extracting broadcast signals of the selected channel (S2). If the microprocessor 11 thereby determines that the tuner 12 of the VTR 1 is capable of extracting broadcast signals of the selected channel (YES in S2), then the microprocessor 11 changes the channel to the selected channel (S3).

On the other hand, if the microprocessor 11 thereby determines that the tuner 12 in the VTR 1 is incapable of extracting broadcast signals of the selected channel (NO in S2), then the microprocessor 11 sends a state check command via the bus to an external device having a tuner capable of extracting broadcast signals of the selected channel (S4). For example, in the case where the channel selected by the user is CS 1, the tuner 12 in the VTR 1 is incapable of extracting broadcast signals of the selected channel. In this case, the microprocessor 11 sends a state check command to the VTR 2, which has a tuner capable of extracting broadcast signals of CS 1 as the microprocessor 11 can determine on the basis of the channel information 60.

In the case where the external device (such as VTR 2), to which the state check command has been sent, sends back a message indicating that the external device is usable (YES in S5), then the microprocessor 11 sends this external device a control command for channel change (S6), and switches the input line of broadcast signals to the recording and reproducing unit 19 of the VTR 1, switching from the internal input line (first input line) to the external input line (second input line) connected to the external device (S7). For example, in the case where the external device having sent back the message indicating that it is usable is VTR 2, the microprocessor 11 sends the a control command for channel change to the VTR 2. The microprocessor 11 further controls the input changeover switch 18 to switch the input line of broadcast signals to the recording and reproducing unit 19 of the VTR 1, switching from the input line 15 to the input line 17 which is for input from the VTR 2 as shown in FIG. 1. When the user, using the remote control device 25, further commands start of video recording, then the microprocessor 11 controls the recording and reproducing unit 19 to record video signals and audio signals input from the VTR 2, as the external device, via the interface 16 and the bus (S8).

On the other hand, in the case where the external device, to which the state check command has been sent, sends back a message indicating that the external device is unusable (NO in S5), then the microprocessor 11 sends a state check command via the bus to a further external device having a tuner capable of extracting broadcast signals of the selected channel (S9). For example, in the case where the channel selected by the user is CS 1, and where the VTR 2 is unusable for some reason such as the VTR 2 is already in a mode of video recording reservation, then the VTR 2 sends back a message indicating that it is unusable. When receiving this message, the microprocessor 11 sends a state check command to the VTR 3, as the further external device, which has a tuner capable of extracting broadcast signals of the channel CS 1 as the microprocessor 11 can determine on the basis of the channel information 60. In the case where the further external device (such as VTR 3), to which the state check command has been sent, sends back a message indicating that the further external device is usable (YES in S10), then the microprocessor 11 subjects this further external device to the process of the above-described S6 to S8. On the other hand, if every one of the external devices, to which the state check command has been sent, sends back a message indicating that the every one of the external devices is unusable (NO in S10), then the microprocessor 11 outputs and displays a message to this effect on the display unit 26 (S11).

As evident from the foregoing, according to the present embodiment, it is possible to select channels not only in frequency bands which the tuner 12 of the VTR 1 is capable of extracting, but also in frequency bands which tuners of other network-connected devices such as the VTR 2 are capable of extracting. In the case where a channel which a tuner of a further network-connected device such as the VTR 2 is capable of extracting is selected, the input line of broadcast signals to the recording and reproducing unit 19 is switched from the input line 15, which is from the tuner 12 of the VTR 1 to the recording and reproducing unit 19 of the VTR 1, to the input line 17, which is from the further network-connected device to the recording and reproducing unit 19 of the VTR 1. In such way, video signals, audio signals and the like input from other network-connected devices are recorded by the recording and reproducing unit 19. Thus, even in the case where a channel of a broadcast program to be recorded is in a frequency band which the tuner 12 of the VTR 1 is incapable of extracting, such broadcast program can be recorded by the VTR 1 if built-in tuner(s) of some other network-connected device(s) is (are) capable of extracting such frequency band.

It is to be noted that the present invention is not limited to the above-described embodiment, and various modifications are possible. For example, although the embodiment illustrates the case where the VTR 1 has a built-in tuner capable of extracting broadcast signals of given kinds, the tuner is not required to be built-in in the VTR 1. Further, according to the above-described embodiment, the memory 23 of the VTR 1 stores the channel information table 56 containing channel information 60 about channels in frequency bands where tuners of other network-connected devices can be tuned, wherein on the basis of the channel information 60 in the channel information table 56, a network-connected device having a tuner capable of extracting the broadcast signals of the channel selected by the user is determined. However, instead, it can be so designed that each time a channel in frequency bands where the tuner 12 in the VTR 1 cannot be tuned is selected by the user, a network-connected device having a tuner which can be tuned to the broadcast signals of the selected channel is determined on the basis of information stored in a register space in each network-connected device.

Furthermore, although the above-described embodiment illustrates the case where the bus-connectable video recording device is a video recording device which can be connected to an IEEE 1394 serial bus, the present invention can also be applied to video recording devices which can be connected to serial buses, such as USB (Universal Serial Bus), other than the IEEE 1394 serial bus. It is to be noted also that the kinds of bus-connectable video recording devices are not limited to VTR, but can be other kinds of video recording devices such as DVD (Digital Versatile Disc) recorder.

The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

This application is based on Japanese patent application 2003-189740 filed Jul. 1, 2003, the contents of which are hereby incorporated by reference.

1. A serial bus-connectable video recording device comprising:
an operating unit to perform operations including channel selection of a channel of a broadcast program to be recorded;
a built-in tuner to extract, from broadcast signals received by an antenna, broadcast signals of a channel selected by a user using the operating unit;
a decoder to separate and decode the broadcast signals, extracted by the built-in tuner, into video signals and audio signals;
a video recording unit to record the video signals and the audio signals decoded by the decoder;
an interface unit to send and receive data via a serial bus to and from a further device on the serial bus, the further device having a further built-in tuner;
an input changeover switch to switch between an input line (hereafter referred to as first input line) of broadcast signals from the built-in tuner of the video recording device via the decoder to the video recording unit and a further input line (hereafter referred to as second input line) of broadcast signals from the further device to the video recording unit; and
a microprocessor to control operations of the operating unit, the built-in tuner, the decoder, the video recording unit, the interface unit and the input changeover switch of the video recording device,
wherein when a channel of a broadcast program to be recorded is selected by a user using the operating unit while the video recording device is connected to the further device via the serial bus,
the microprocessor controls the built-in tuner of the video recording device to extract broadcast signals of the channel selected by the operating unit, while maintaining the first input line as the input line of broadcast signals to the video recording unit, in the case where the broadcast signals of the channel selected by the operating unit are broadcast signals in a given frequency band which the built-in tuner of the video recording device is capable of extracting, and
the microprocessor sends a control command for channel change to the further device, and controls the input changeover switch to switch the input line of broadcast signals to the video recording unit from the first input-line to the second input line in order for the further built-in tuner of the further device to extract the broadcast signals of the channel selected by the operating unit, in the case where the broadcast signals of the channel selected by the operating unit are broadcast signals in a further given frequency band which the built-in tuner of the video recording device is incapable of extracting, and which the further built-in tuner of the further device is capable of extracting.

2. The serial bus-connectable video recording device according to claim 1, which further comprises channel storage means to store channel information corresponding to broadcast signals which the built-in tuner of the video recording device is capable of extracting as well as channel information corresponding to broadcast signals which the further built-in tuner of the further device is capable of extracting,
wherein on the basis of the channel information stored in the channel storage means, the microprocessor determines whether the broadcast signals of the channel selected by the operating unit are broadcast signals which the built-in tuner of the video recording device is capable of extracting or are broadcast signals which the further built-in tuner of the further device is capable of extracting.

3. The serial bus-connectable video recording device according to claim 2, which the serial bus is an IEEE 1394 serial bus, and the interface unit is an interface circuit to send and receive data to and from the further device on the IEEE 1394 bus.

4. The serial bus-connectable video recording device according to claim 1, which the serial bus is an IEEE 1394 serial bus, and the interface unit is an interface circuit to send and receive data to and from the further device on the IEEE 1394 bus.
